(19) United States
(12) Patent Application Publication
(10) Pub. No.: US 2007/0124607 A1
(43) Pub. Date: May 31, 2007

(54) System and method for semi-automatic power control in component architecture systems

(75) Inventor: Alden Fuchs, Monument, CO (US)

Correspondence Address: Kenneth L. Sherman, Esq.;Myers Dawes Andras & Sherman, LLP, 11th floor, 19900 MacArthur Blvd., Irvine, CA, 92612, US

(73) Assignee: Samsung Electronics Co., Ltd., Suwon City (KR)

(21) Appl. No.: 11/291,675

(22) Filed: Nov. 30, 2005

(51) Int. Cl. G06F 1/26

(52) U.S. Cl. 713/300

(57) ABSTRACT

A semi-automatic power control in component architecture system is provided. Using a component based hardware (HW) and software (SW) architecture, semi-automatic power control in component architecture systems is achieved. Further, intelligent power control in heterogeneous architectures is achieved by the knowledge of the data communications between components, both hardware and software. The analysis of the data traffic, embedded-in the traffic clues, and/or special messages, enable a decentralized highly efficient semi-automatic power control scheme to be employed on SOC, and extended to the rest of the digital processing systems within one device or system.

### FIELD OF THE INVENTION

The present invention relates to semi-automatic power control, and in particular to semi-automatic power control in component architecture systems using SOC.

### BACKGROUND OF THE INVENTION

With the proliferation of system-on-chip (SOC) designs wherein an entire manufactured circuit system is placed on a single chip, power consumption control and reduction for SOCs is becoming more important. This is because an SOC includes many different types of components such as data processors, signal processors, memory, controllers, clocks, etc., which all consume power and generate heat. To increase the longevity of the power supplies for these devices, and especially for portable devices which require a portable power source, power consumption of the SOCs must be reduced from their current levels.

U.S. Application Publication Nos. 20020152407, 20020184547, 20040019814 discuss a central controller that can turn off the clock to components based on a central command. The disadvantage to this is the difficulty in passing application state information to the central controller from the applications. In an SDR (Software Defined Radio), or SOC, this central control is made difficult by the fact that it will need to know the status of all the tasks in the system, and the status has to be communicated to it. This poses a serious overhead in the SOC for just communicating status information around. Further, U.S. Application Publication No. 20040088630 discusses a central controller that can turn off components, and also saves the state and data before power down. In this approach a central controller is also discussed as the mechanism to initiate the power down sequence.

Heterogeneous architectures are not just made of programmable processors, there are components that lack the ability to use high level software interfaces. This results in the need for much hand coding and optimization for complex devices such as multi-core DSP processors to achieve central power control. Further, a custom power control interface for a hardware component must be built into the application code, wherein the application decides which parts to moderate the power consumption of.

### BRIEF SUMMARY OF THE INVENTION

The present invention provides semi-automatic power control in component architecture systems. In one embodiment, using a component based hardware (HW) and software (SW) architecture, semi-automatic power control in component architecture systems can be provided. In such a component based architecture, both hardware and software functions are encapsulated. The encapsulation provides: software component reuse; hardware component reuse; reduction in software and hardware bugs; facilitating faster design and time to market of products derived from the use; software portability for heterogeneous system on chip (SOC) architectures; ease of software coding on complex heterogeneous SOC chips; and intelligent and efficient power control within SOC chips, and the external digital systems.

Further, intelligent power control in heterogeneous architectures is achieved by the knowledge of the data communications between components, both hardware and software. Signal processing is carried out on packets of data packaged into messages sent between the components. By using analysis of the data message traffic, meta-data embedded-in the message, and/or special messages, enable a decentralized highly efficient semi-automatic power control scheme to be employed on SOC. The component which implements this interface and provides implementation of the local power control is called an auto power node “APx”. These nodes can be easily extended outside of the SOC to the rest of the digital processing systems spanning multiple devices, a complete system.

Heterogeneous architectures are not just made of programmable processors, so there are components that lack the ability to use high level software interfaces like data messages. As such, according to an embodiment of the present invention, special purpose programmable devices auto-power node (Semi-Automatic SOC Power controllers) are utilized which implement in hardware the conversion from the HW device native data format to a message transport format. Such devices in conjunction with a data transport like crossbars, busses, packet switches can be used to interconnect internal components of a multi-core SOC such that software development and fine grain power control becomes much easier and portable.

In a semi-automatic power control system according to an embodiment of the present invention, the system utilizes the processing requirements which are embedded using Meta-data in the given data message packet. This information is used to turn on/off and scale clocks and voltage to save system power. The data in the message is then presented in the correct format for the receiving signal data processing component controlled by the AP node. By having a high level understanding of a power algorithm (e.g., the entire set of processing done on a SOC) the system will know which hardware components are not being used during the current arbitrary time interval, and can pause the unused hardware and software components. One way an auto power node can achieve this is by stopping the clock to the component since it is known that there are no active connections, and/or no messages in the input queue, thereby achieving system power savings.

These and other features, aspects and advantages of the present invention will become understood with reference to the following description, appended claims and accompanying figures.

### BRIEF DESCRIPTION OF THE DRAWINGS

FIG. 1 shows a block diagram of an example computer architecture system including semi-automatic power control according to an embodiment of the present invention.

FIG. 2 shows a functional block diagram of an embodiment of an auto power controller (AP) of FIG. 1, according to an embodiment of the present invention.

FIG. 3 shows a flowchart of example steps of the Receive function implemented by the Interconnect Interface Component in FIG. 2.

FIG. 4 shows a flowchart of example steps of the Transmit function implemented by the Interconnect Interface Component in FIG. 2.

FIGS. 5-6 show flowcharts of example steps implemented by the Interconnect Interface Component in FIG. 2.

FIG. 7 shows an example Cross Bar switch implementation wherein hardware components are connected to the switch, according to an embodiment of the present invention.

### DETAILED DESCRIPTION OF THE INVENTION

The present invention provides semi-automatic power control in component architecture systems. In one embodiment, using a component based hardware (HW) and software (SW) architecture, semi-automatic power control in component architecture systems can be provided. In such a component based architecture, both hardware and software functions are encapsulated. The encapsulation provides: software component reuse; hardware component reuse; reduction in software and hardware bugs; facilitating faster design and time to market of products derived from the use; software portability for heterogeneous system on chip (SOC) architectures; ease of software coding on complex heterogeneous SOC chips; and intelligent and efficient power control within SOC chips, and the external digital systems.

Further, intelligent power control in heterogeneous architectures is achieved by the knowledge of the data communications between components, both hardware and software. The analysis of the data message traffic, embedded-in the data message meta-data, and/or special messages enable a decentralized highly efficient semi-automatic power control scheme to be employed on SOC, and extended to the rest of the digital processing systems within one device or system.

According to an embodiment of the present invention, since the On/Off and power scaling by frequency and voltage is based on Meta-data contained in the data flow from and to each component, no central knowledge of system status (state) is required. As such, the present invention provides a data driven model vs. the aforementioned conventional central state models. A data message packet and its meta-data supply all the information necessary to achieve power control for a HW component. This means that no additional code needs to be written to enable power control over the HW components. Further, effective system power control is achieved by a decentralized local control based on the processing needs of the data message packets and their meta-data queued for a given component. The meta-data provides information about percentage of CPU bandwidth a data message needs, the latency requirements of the data message, priority, local memory requirements, cash requirements, register usage, dependences on other data messages, etc.

Unlike the conventional systems, according to the present invention there is no need for an explicit method to save data and state, because the Voltage Frequency scaling circuitry would keep the component in sleep mode, and only shut down when critical power shortage and or application driven event triggered the complete shut-down.

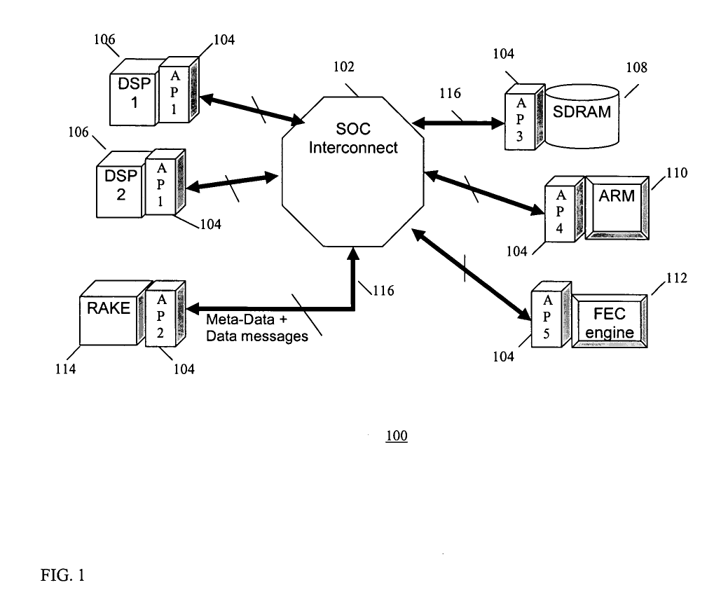

Referring to the functional block diagram of FIG. 1, an example computer architecture system 100 includes semi-automatic power control according to an embodiment of the present invention. The computer architecture system 100 includes hardware components that can either be on a single SOC or multiple chips interconnected. Example hardware components include subsystems such as:
SDRAM 108: a memory subsystem.
ARM 110: a general purpose processor subsystem.
FEC 112: a reconfigurable ASIC subsystem (e.g., a reconfigurable forward error correction “FEC” engine subsystem).
RAKE 114: a specific ASIC block that performs signal processing.
DSP 106: a programmable signal processor subsystem (e.g., DSP1, DSP2, etc.).

FIG. 1 illustrates semi-automatic power control implemented as Semi-Automatic SOC Power control (Auto Power “AP”) devices 104 according to an embodiment of the present invention. Each AP 104 (e.g., AP1, AP1, AP2, AP3, AP4, AP5) comprises the hardware and/or software component that interfaces the respective IC Core subsystems e.g. SDRAM 108, ARM 110, FEC 112, RAKE 114, DSP 104, etc., to the SOC interconnect(s) 102 supplied on the SOC. Each connection 116 communicates information including meta-data and data messages between each AP 104 and SOC the interconnect 102. Generally, the inter-component communications is message based, but it can be extended to streaming and other methods as those skilled in the art recognize.

The SOC Interconnect 102 comprises a dynamically reconfigurable or static interconnect bus or fabric. A fabric being packet switched, cross bar or of other designs. The interconnect 102 can also be radio link, optical link or other network as those skilled in the art recognize. This interconnect 102 is used to connect the components together into a complete system.

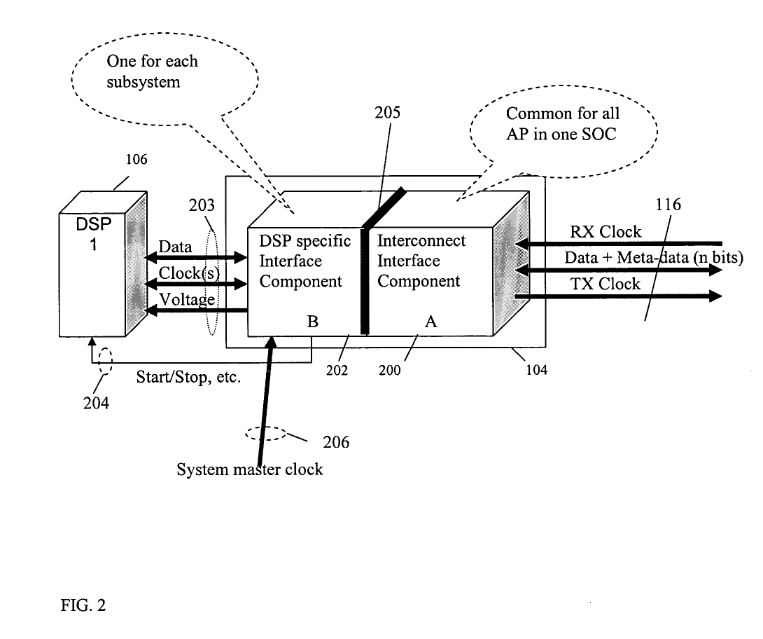

FIG. 2 shows a functional block diagram of an embodiment of an AP 104 (e.g., AP1), according to an embodiment of the present invention. The example AP 104 comprises an Interconnect Interface Component (part “A”) 200 and a device Specific Interface Component (part “B”) 202. The Interconnect Interface Component 200 connects to the Interconnect 102 that is used in a specific SOC. The device Specific Interface Component 202 translates from the custom/device interconnects for each subsystem IC signal processing component (e.g., DSP subsystem 106) into an intermediate representation that connects to the Interconnect Interface Component 200.

The Interconnect Interface Component 200 functions include a Receive function and a Transmit function, described hereinbelow. In the following description, the term subsystem refers to the multiple devices (e.g. subsystem devices 106, 108, 110, 112, 114, etc.) that are connected to the interconnect 102 via the AP nodes 104 as shown by example in FIG. 1.

In the example shown in FIG. 2, the inputs and outputs for AP 104 are generalized for clarity, and as those skilled in the art will recognize any HW method for sending data messages to/from subsystems can be used. RX Clock, TX Clock, Data+Meta-data represent the interconnect 116. Data, Clock(s), Voltage, Start/Stop etc., represent the specific interconnect between say subsystem 106 and device specific interface 202.

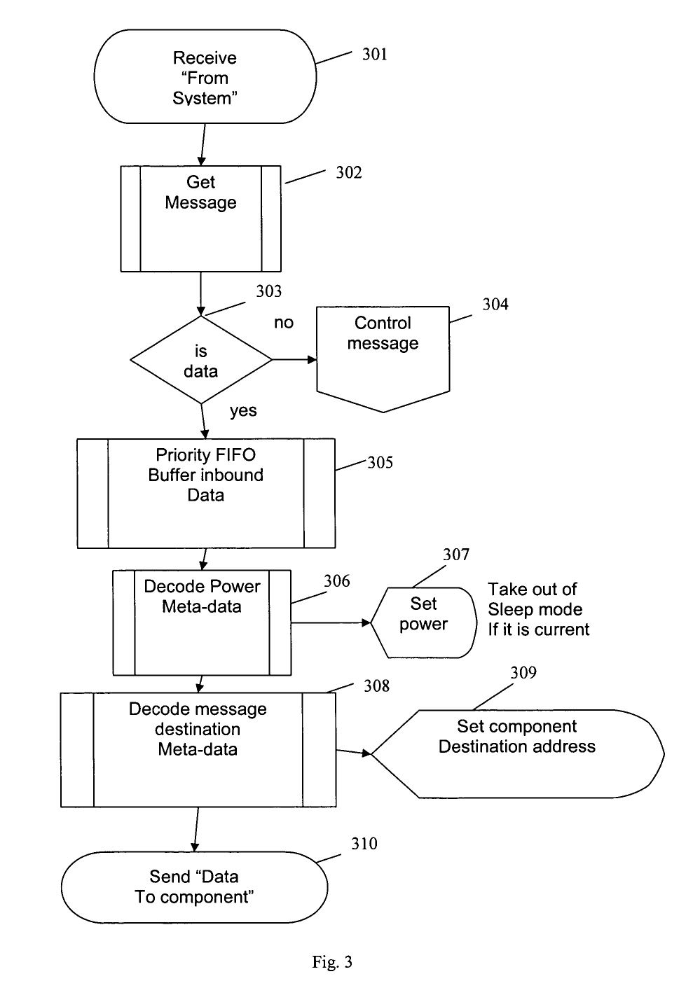

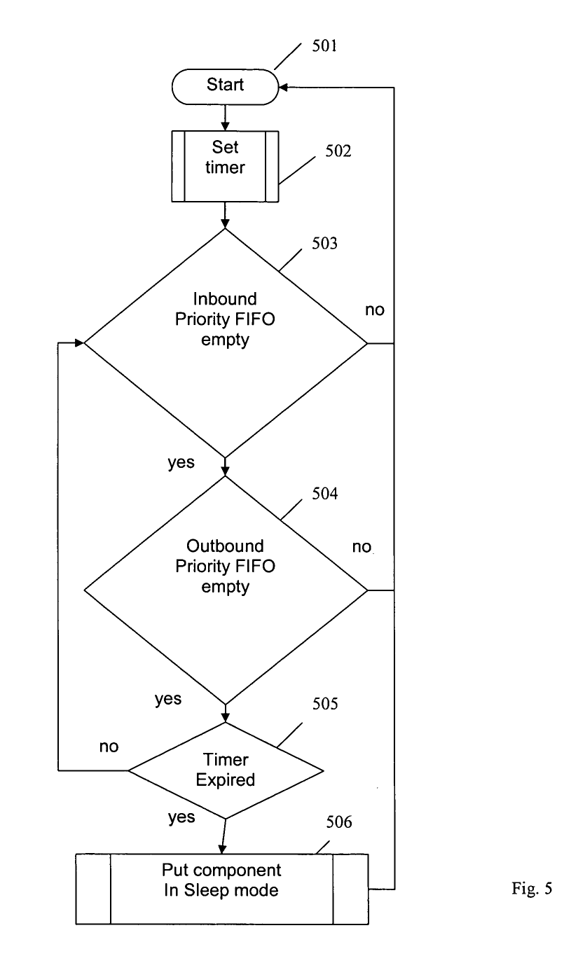

Referring to the example steps in the flowchart of FIG. 3, the Receive function of the Interconnect Interface Component 200 implements the steps of:
301 & 302: Receiving data message packets from the other subsystems through the Interconnect 102.
303: Test if the message is a data message or a control message.
304: If Control message, decode message and implement actions e.g. Turn off subsystem controlled by device interface component 202 (e.g., FIG. 5, step 507).
305: Buffer the data message packets in a queue (e.g., FIFO, Priority carried by the Meta-data in the data packet, etc.).
306: Decode the work effort Meta-data. This data is inserted at run time and comes from source component initiation and is calculated at design time by benchmarking, etc. The data is inserted into the message by software on subsystems 110, 106. For subsystems such as 112, 114, this data is inserted by interconnect interface component 200 from local memory.
307: The interconnect interface component 202 sets the clock frequency for the subsystem (e.g., subsystem 106) connected to the device specific interface 202. If the previous state was ‘sleep’, bring the subsystem out of sleep state. The auto power node 104, device specific interface 202, then sets the voltage and frequency for the subsystem based on the meta-data.
308: Interconnect interface component 200 Decodes the data message destination address according to the meta-data.
309: Device specific interface 202 sets destination addresses and/or register values to enable transfer of the data message to the subsystem HW device (e.g., subsystem 114). HW signal processing device 114 under control of the auto-power node 104 is a message destination device.
310: Perform the actual data transfer from device specific interface 202 to subsystem 114 into the specified register, memory location, FIFO, etc.

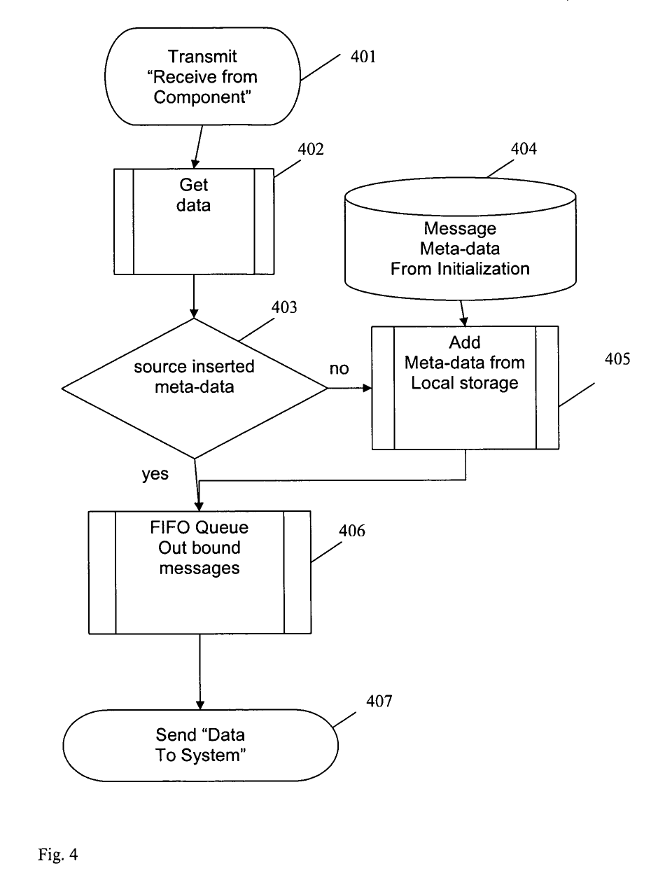

Referring to the example steps in the flowchart of FIG. 4, the Transmit function of the Interconnect Interface Component 200 implements the steps of:
401: Device interface component 202 receives notification that data from the subsystem (e.g.,106, 114, etc.) which is read to be transmitted to another subsystem.
402: Retrieve the data from the subsystem controlled by device interface component 202.
403: In some realizations of device interface component 202 (e.g., for subsystems 114, 112, 108) determining if source inserted meta-data will result in using performing steps 404 and 405. For other realizations of device interface component 202 (e.g., for subsystems 106, 110), steps 404 and 405 will not be performed.
404: Store the meta-data for each message type being sent by the subsystem. This data store is initialized at system boot and during other major configuration changes.
405: Format the transmit Data message packet and add Meta-data specifically from component initialization meta-data (step 404) and/or calculations if required. 406: Queue the transmit data packets (e.g., FIFO, or based on Priority in the Meta-data, etc.).
407: Send the transmit message onto the system interconnect 116 to a subsystem specified in the meta-data destination subsystem (e.g., subsystem 110 sends a message to subsystem 112).

The device Specific Interface Component 202 functions as shown in FIG. 2 include:
203: Converting the signaling (control signals, and method of access parallel, multiplexed bus etc.) and bus width, etc. into an intermediate form 205 ready for the Interconnect Interface Component.
204: Converting the control and logic signals from Interconnect Interface Component into physical signals for the subsystem under control of the Auto-power node (e.g., Start, Stop, etc.)
206: Taking the system master clock signal and producing the Voltage/Frequency scaling valid for the subsystem based on the calculated work effort based on the data message meta-data from Interconnect Interface Component.

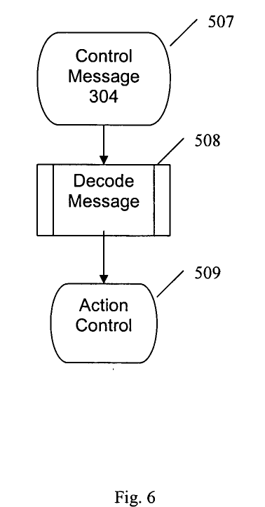

Referring to the example steps in the flowchart of FIGS. 5-6, the Interconnect Interface Component 200 (Part A, FIG. 2) implements parts of the semi-automatic power save, using a sleep state algorithm including the steps of:
501: Initial state.
502: Set the timer which regulates the amount of inactivity time that is required before subsystems 106, 110, 114, 112, etc., are automatically put into sleep state.
503: When there is no data is in inbound FIFO 305 the next test is performed, else go to start state 501.
504: When there is no data is in outbound FIFO 406 the next test is performed, else go to start state 501.
505: Test if the timer has expired.
   If timer has timed out go to step 506, put subsystem to sleep.
   If timer has not expired go to step 503, continue testing the FIFOs.
506: Transmit and Receive Queues are empty, so the auto-power node is responsible for putting the subsystem into sleep mode to provide for very low power consumption. For various different HW subsystems, sleep will have different requirements and effects.
507: The Interconnect Interface Component 200 receives a control message signal 304 (e.g., “no more data messages will be received”).
508: Decode control message.
509 Action Control message. Possible control message commands can be received e.g.:
   start, stop, hibernate, shutdown, etc.,
   Last data message.
   Reconfigure system and initialization data.
   Whatever is embedded in the in the control message.

Hardware components are self-contained i.e. if special configuration nonvolatile memory, or volatile memory is needed this is considered part of the component and any optimizations etc are not part of this invention.

Software components include e.g. processes, threads, applications, etc., that run on programmable processors such as GPP, DSP, and embedded processors in FPGA's and SOC. These software components use a middleware such as IP sockets, CORBA ORB, etc., to communicate between each other. In this component model the software components can also communicate with hardware components using this middleware just like the hardware was another software process, etc.

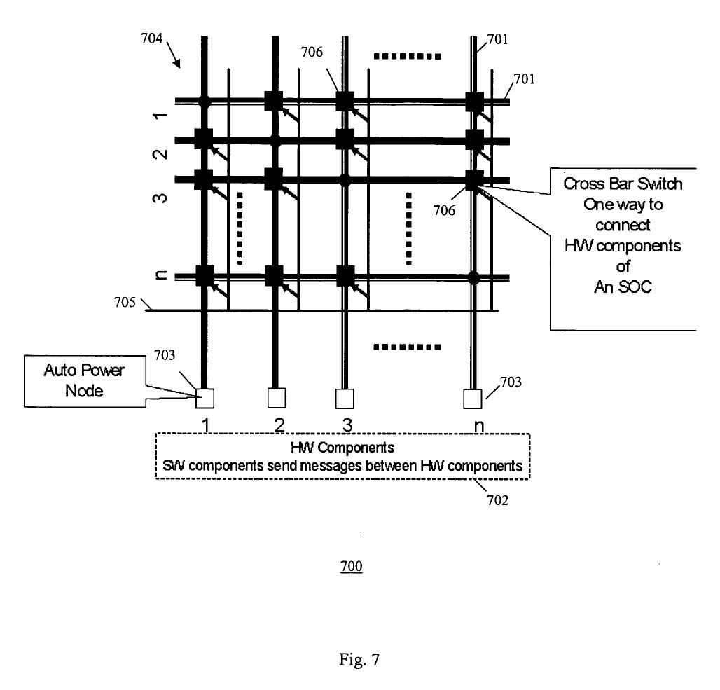

FIG. 7 shows an example system 700 providing a Cross Bar switch implementation of the SOC Interconnect 102 of FIG. 1, wherein multiple subsystems 702 (1 to n) are connected via Cross Bar switch 704 (values 1 to n on the vertical left of FIG. 7 are the lanes used to implement the crossbar switch). Further, communication lines 701 provide pathways for information including control, clock and data signals. Lines 705 are the crossbar control signals. Each subsystem 702 is connected to an auto power bus interface node (AP) 104 shown in FIG. 7 as node 703, wherein each node 703 is specific to the family of corresponding subsystem 702. Note that the nodes 706 are the crossbar switches for each cross bar lane. There are n bus interface auto power nodes 703 (i.e., AP 104) for n corresponding subsystem devices 702 of types 108,110,112, 106, 114, etc. (FIG. 1).

According to the present invention intelligent power control in heterogeneous architectures is achieved by the knowledge of the data communications between components, both hardware and software. The analysis of the data traffic, embedded-in the traffic clues, and/or special messages enable a decentralized highly efficient semi-automatic power control scheme to be employed on SOC, and extended to the rest of the digital processing systems within one device or system.

What is claimed is:

1. A power control system for an integrated circuit device including multiple power consuming components, the power controller comprising:
a power controller including a power supply control unit which utilizes knowledge of the data communications between a corresponding component and other components, to control power supply to said corresponding component.

2. The system of claim 1 wherein:
the components are interconnected via communication nodes; and
the power controller utilizes the interconnect requirements for the given meta-data included in the data message to control each power supply control unit accordingly to turn off signal processing subsystem nodes, scale back clocks and/or control voltages in order to control power consumption for saving power.

3. The system of claim 1 wherein the power controller utilizes information about processing performed by the components of the integrated circuit device to determine components not being used during an interval, wherein the power controller selectively controls each power supply control unit to accordingly control power supply to the unused components.

4. The system of claim 3 wherein:
the power controller includes a plurality of power control units; and
each power control unit controls an associated interconnect node whereby the interconnect node stops the clock to the unused component to achieve power savings.

5. The system of claim 1 wherein the power controller includes a plurality of power supply control units, each power supply control unit corresponding to a component of the integrated device.

6. The system of claim 5 wherein:
the integrated circuit device further includes an interconnect module; and
each power supply control unit comprises an interface node, wherein each interface node connects a corresponding component to the interconnect module, the interconnect module providing communication paths between the components.

7. The system of claim 6 wherein each interface node comprises a Interconnect Interface and a device Specific Interface, wherein the Interconnect Interface connects the interface node to the interconnect module and the device Specific Interface connects the interface node to the corresponding component.

8. The system of claim 7 wherein each device Specific Interface provides conversion from the native data format of the corresponding component to the interconnect module transport format.

9. The system of claim 8 wherein each device Specific Interface provides conversion from the native data format of the corresponding component to the interconnect module transport format in a power efficient manner.

10. The system of claim 8 wherein each device Specific Interface provides efficient fine grain power control.

11. The system of claim 8 wherein each Interconnect Interface provides a receive function and a transmit function.

12. The system of claim 11 wherein the transmit function of the Interconnect Interface further:
formats transmit data packets and adds work effort meta-data to the data packets;
queues the transmit data packets into an output queue;

13. The system of claim 12 wherein the receive function of the Interconnect Interface further:
receives data packets from the other components through the interconnect module;
buffers received data packets in an input queue;
decodes work effort meta-data from the next data packet from the input queue;
sets the clock frequency for the corresponding component based on the meta-data in the data message;
sets the voltage for the corresponding component; and
sets destination addresses and/or register values for the data message packet.

14. The system of claim 13 wherein the device Specific Interface further:
converts the signaling and bus width of the interconnect module into intermediate form for the Interconnect Interface;
converts the logic signals of the component under control, the logic signals including data bus receive (RX) clock, transmit (TX) clock and direction signals for the Interconnect Interface;
uses a master clock signal and generates a Voltage/Frequency scaling valid for the corresponding component based on the work effort signals from Interconnect Interface;
when no data in both the input and output queues, places the corresponding component into sleep mode;
when the Interconnect Interface receives a control message that signals that no more data will arrive and places the controlled HW signal processing component into start, stop, hibernate or shutdown, as appropriate based on the contents of the control message.

15. The system of claim 1 wherein the integrated circuit device comprises a component architecture system.

16. The system of claim 1 wherein the integrated circuit device comprises a system on chip device.

17. The system of claim 1 wherein the components include hardware and/or software components.

18. The system of claim 1 wherein hardware and software components are encapsulated.

19. The system of claim 1 wherein each power supply control unit further provides semi-automatic power control.

20. A decentralized power control method for an integrated circuit device including multiple power consuming components, comprising the steps of:
utilizing knowledge of the data communications between a corresponding component and other components, to control power supply to said corresponding components.

21. The method of claim 20 wherein the data communication to a component includes work packet and associated meta-data.

22. The method of claim 21 wherein the steps of controlling power supply to each component further includes the steps of: performing power scaling by frequency and voltage based on meta-data contained in the data flow from and to the component, wherein in no central knowledge of the integrated circuit device system status is required.

23. The method of claim 21 wherein a work packet and its meta-data supply all the information necessary to achieve power control for a component.

24. The method of claim 21 wherein utilizing knowledge of the data communications between a corresponding component and other components, to control power supply to said corresponding components further includes the steps of providing power control via decentralized local control based on the needs of the work packets and their meta-data queued for each component.

25. The method of claim 21 wherein the meta-data includes information about percentage of CPU bandwidth a work packet needs and the latency requirements of the packet.

26. The method of claim 25 wherein the steps of controlling power supply to each component further includes the steps of: performing Voltage Frequency scaling based on the meta-data contained in the data flow from and to the component, wherein an unused component is maintained in sleep mode, and only shut down when critical power shortage and or application driven event triggers a complete shut-down.
